(19) United States
(12) Patent Application Publication
(10) Pub. No.: US 2014/0129982 A1
(43) Pub. Date: May 8, 2014

(54) METHOD AND SYSTEM FOR SUPPORTING CREATION OF IDEAS

(71) Applicant: Taek sang Yoo, Seoul (KR)

(72) Inventor: Taek sang Yoo, Seoul (KR)

(21) Appl. No.: 14/127,517

(22) PCT Filed: Jun. 15, 2012
(86) PCT No.: PCT/KR2012/004720

§ 371 Date: Dec. 19, 2013

(30) Foreign Application Priority Data
Jun. 20, 2011 (KR) 10-2011-0059847

(51) Int. Cl. G06F 3/0482

(52) U.S. Cl. CPC G06F 3/0482
USPC 715/810

(57) ABSTRACT

Disclosed herein is a method and system for supporting the creation of ideas, which efficiently manages the ideas of a user as data in an idea creation supporting system for supporting the creation of ideas, thus supporting the creation of ideas of the user. Data is received from a user and an object including the data is generated. The generated object is arranged in an arbitrary locative space, and location information about part of one or more objects including the generated object is received from the user.

### TECHNICAL FIELD

The present invention relates, in general, to a method and system for supporting the creation of ideas and, more particularly, to a method and system for supporting the creation of ideas, which allows a user to create new ideas from existing ideas.

### BACKGROUND ART

New ideas may be created by newly constructing existing ideas. That is, new ideas can be created while a repeated procedure for selecting suitable ideas from among a plurality of ideas, newly constructing ideas depending on the correlation between the selected ideas, and checking which meanings have been newly created using the above construction is performed. However, a human brain has limitations in terms of the number of ideas that can be handled by imagination, or the scale in which ideas can be constructed. Therefore, there is required a tool for giving support so that imagined ideas can be more easily embodied and new ideas can be derived from the ideas.

Meanwhile, recently, a large number of terminals, such as iPhone, iPad, and BlackBerry, for providing user-friendly interfaces have been popularized. The user of such a terminal can easily record his or her desired contents on the terminal, but this terminal enables only the recording of ideas and does not aid in embodying new ideas via the recording of the ideas. Therefore, there is required a tool for creating new ideas using such a terminal

### DISCLOSURE

### Technical Problem

Accordingly, the present invention has been made keeping in mind the above problems occurring in the prior art, and an object of the present invention is to create new ideas.

Another object of the present invention is to provide a tool for facilitating the creation of new ideas.

A further object of the present invention is to easily visualize one or more ideas and easily determine structures between the ideas.

Yet another object of the present invention is to enable structures between ideas to be determined in a short period of time.

Still another object of the present invention is to support the inductive thinking of a user.

Still another object of the present invention is to allow a user to simulate structures between ideas and to continuously change the structures between the ideas based on the results of the simulation, thus finding a suitable structure between the ideas.

### Technical Solution

In order to accomplish the above objects, the present invention provides a method of managing data in an idea creation supporting system for supporting creation of ideas of a user, including receiving data from the user, generating an object including the data, and arranging the generated object in an arbitrary locative space; and receiving location information about parts of one or more objects from the user, the one or more objects including the generated object.

Preferably, the method may further include receiving a connective relationship between the parts of the one or more objects.

Preferably, the method may further include outputting data included in the one or more objects as a file.

Preferably, the method may further include allowing parts of the one or more objects to be selected; and outputting data included in the parts of the one or more objects as a file in a sequence in which the objects are selected.

Preferably, the method may repeatedly perform operations ranging from the arranging the generated object in the arbitrary locative space to the receiving the location information about the parts of the one or more objects.

Preferably, the location information may denote a distance relative to any object.

Preferably, the receiving the location information about the parts of the one or more objects may further include additionally generating a certain locative space other than an existing locative space.

Preferably, the additionally generating the certain locative space may further include extending a dimension of the existing locative space.

Preferably, the receiving the location information about the parts of the one or more objects may further include duplicating or shifting the parts of the one or more objects.

Preferably, the receiving the connective relationship between the parts of the one or more objects may further include receiving a hierarchical relationship between the parts of the one or more objects.

Preferably, the locative space may include a locative space that can be accessed by a certain user other than the user.

Preferably, an object included in the locative space that can be accessed by the certain user can be duplicated or shifted by the certain user.

### Advantageous Effects

The present invention can create new ideas. Further, the present invention can provide a tool for facilitating the creation of new ideas. Furthermore, the present invention can easily visualize one or more ideas and easily determine structures between the ideas.

Furthermore, the present invention can detect structures between ideas in a short period of time. Furthermore, the present invention can support the inductive thinking of a user. Furthermore, the present invention can simulate structures between ideas and continuously change the structures between the ideas based on the results of the simulation, thus finding a suitable structure between the ideas.

### BRIEF DESCRIPTION OF DRAWINGS

FIGS. 1 and 2 are diagrams showing the configuration of a system according to an embodiment of the present invention;

FIG. 3 is a flowchart showing a method according to an embodiment of the present invention; and

FIGS. 4 to 18 are diagrams showing embodiments of the present invention.

### MODE FOR THE INVENTION

Hereinafter, embodiments of the present invention will be described with reference to the attached drawings, but the present invention is not limited to these embodiments. In the present specification, the same reference numerals are used throughout the different drawings to designate the same or similar components.

The present invention is capable of displaying ideas so that they can be viewed at a glance using a virtual space (for example, the screen of a smart phone) that can be provided on an electronic device (for example, a smart phone, a mobile terminal, or the like) and that can be visualized, and is also capable of changing such a display. That is, the present invention allows a user to change a conceptual relation (a correlation or a conceptual inclusive relation) between ideas into a spatial relation (a distance or an inclusive relation between hierarchical locations and spaces) via the electronic device, thus allowing the user to intuitively determine ideas (while simulating the structures of the ideas) and to attempt semantic construction between the ideas. For example, since the user can view the ideas at a glance while implementing the present invention, correlations between ideas can be intuitively and easily determined Further, since ideas can be freely arranged in a space, the user can arrange ideas having a higher correlation to be close to each other, or arrange ideas depending on hierarchy between the ideas (a conceptual inclusive relation between the ideas). As a result, a relation between randomly thought ideas can be easily recognized and new ideas can be created based on the relation.

Further, the present invention can extend a locative space in which ideas are recorded to n dimensions, and can shift/duplicate ideas to other locative spaces or exchange ideas between locative spaces of different dimensions while covering various dimensional spaces, so that independent locative spaces for respective dimensions can be constructed, thus enabling the ideas to be configured and managed.

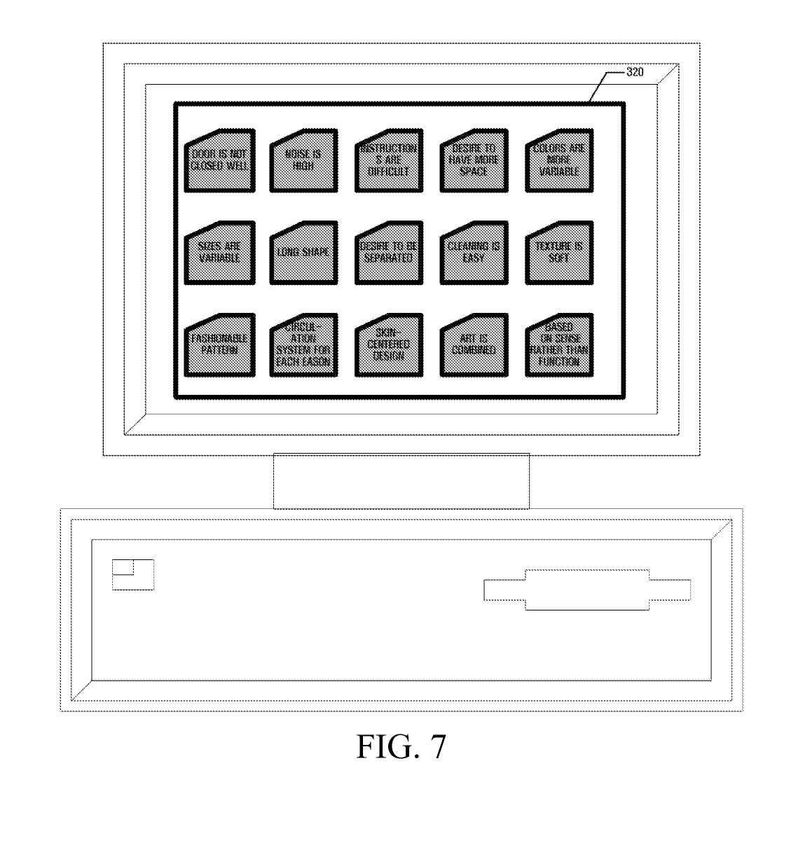

Prior to the description of preferred embodiments of the present invention, the following terms are defined. In the present specification, the term “data” denotes a thing processed such that an idea that has occurred to the user can be managed by a system for supporting the creation of ideas. The term “object” in the present specification is an object for visualizing the data to the user. The term “object” may have the shape of, for example, a note, as shown in FIG. 7, and may be visualized to the user in a form in which data contained in the object is indicated on the note. Further, the term “locative space” in the present specification denotes a space in which the object is located, and may be represented by, for example, a two-dimensional (2D) locative space 320, as shown in FIG. 7. Of course, the term “locative space” can exist even in spaces that can be virtually extended to three or higher dimensions, that is, n dimensions. For example, the locative space 320 of FIG. 7 is a 2D space, but it is extended to three dimensions so as to structure the relations between objects, that is, ideas, arranged in the locative space 320, and, as a result, locative spaces 330, 340, and 350 are generated. Such locative spaces may be arranged in n dimensions and may exhibit hierarchical (superordinate and subordinate) relationships between objects. For example, on the basis of a certain object in a 2D locative space, objects located above the certain object can be defined as superordinate concepts and objects located below the certain object can be defined as subordinate concepts. Further, if a 2D locative space is extended and then several 3D locative spaces are generated, the generated locative spaces may be locative spaces including objects corresponding to the subordinate concepts of the original 2D locative space. Meanwhile, the term “location information” denotes the location of an object in “locative space.” Such “location information” needs only to indicate relative locations of objects. On the basis of the location information of an object arranged at any location in a certain locative space, location information of the remaining objects are determined

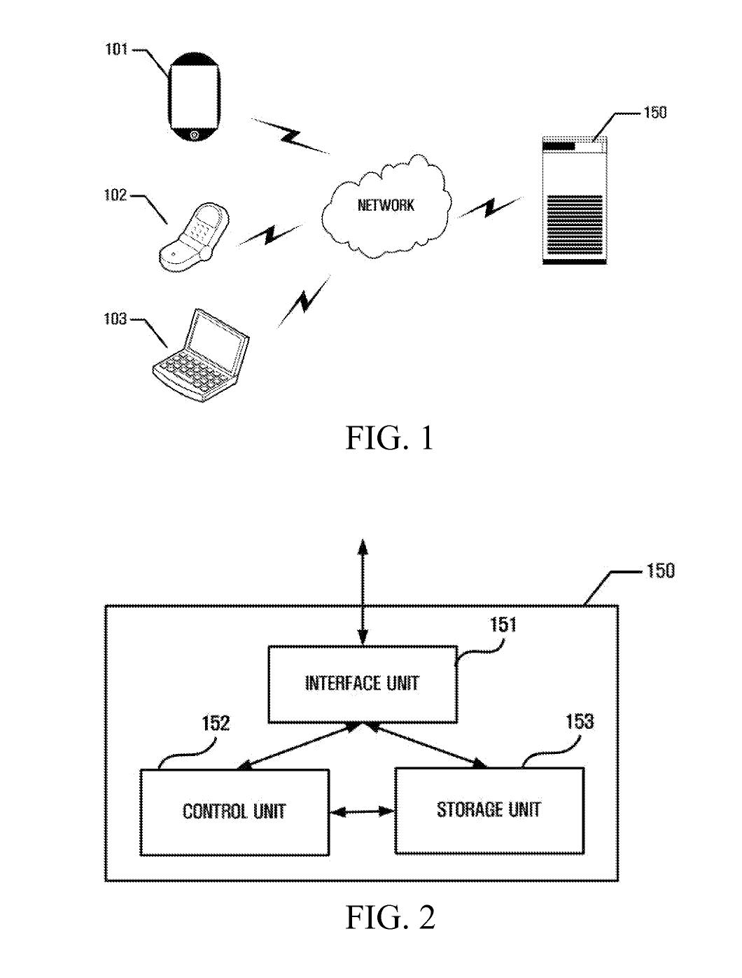

FIG. 1 is a diagram showing the configuration of the overall system related to an embodiment of the present invention, and FIG. 2 is a block diagram for embodying the system of FIG. 1 for supporting the creation of ideas.

Terminals 101, 102, and 103 are electronic devices capable of communicating with a user and processing information, and may include a personal computer (PC), a mobile communication terminal, a personal digital assistant (PDA), a smart phone, a notebook computer, or the like. An idea creation supporting system 150 is a system that supports the creation of ideas of the user and that builds the user's ideas into data and manages the data so as to create the user's ideas. The idea creation supporting system 150 can be communicatively connected to the terminals 101, 102 and 103 over a network and then be accessed by the user. In addition, the idea creation supporting system 150 can either include the terminals 101, 102, and 103 or be included in the terminals 101, 102, and 103.

Referring to FIG. 2, the idea creation supporting system 150 includes an interface unit 151, a control unit 152, and a storage unit 153 which take charge of functions which will be described later. These components can communicate with one another, and can be respectively implemented as different hardware systems, and as software modules for performing inter-process communication in a single physical system.

The idea creation supporting system 150 can communicate with the user via the interface unit 151, and the interface unit 151 may include an output unit (not shown) for displaying objects to the user and an input unit (not shown) for receiving idea input from the user. The interface unit 151 may receive data (that is, the recording of ideas) from the user, and display the received data via the output unit. For example, the user records his or her ideas on the screen of a smart phone having a touch function, and ideas recorded recently on the screen of the smart phone can be displayed together with ideas that were previously recorded. Those skilled in the art will appreciate that an interface unit can be provided using various methods enabling interactions to be performed between the user and the system.

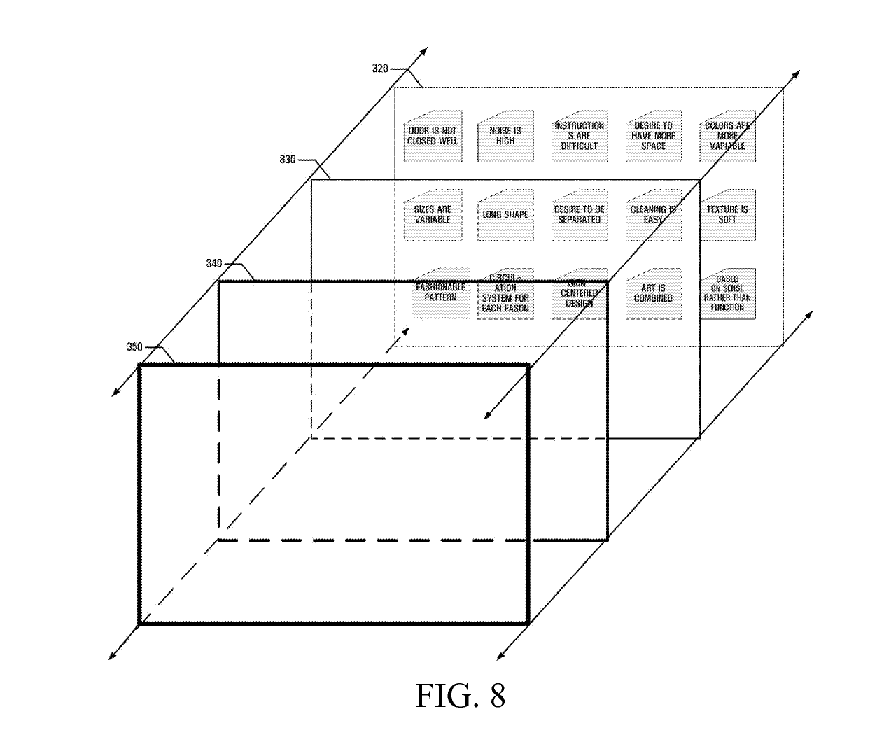

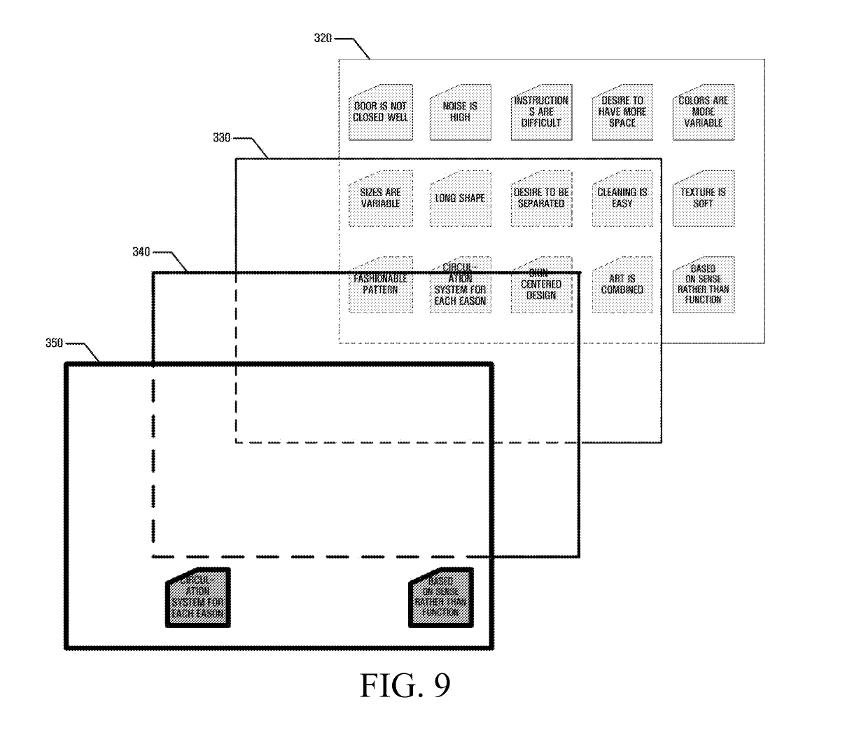

When the user inputs data, the idea creation supporting system 150 generates an object corresponding to the data input via the control unit 152. The control unit 152 can randomly allocate location information to the generated object. Further, when the location information of the data, together with the data input of the user, are input (that is, if the data is arranged at a specific location in a locative space when the user initially inputs the data), the control unit 150 includes the location information and the data in the object. Furthermore, the control unit 152 can generate a new locative space, and can extend the dimension of the locative space to n dimensions. Furthermore, when one object is shifted from one locative space to another locative space, the control unit 152 newly updates the location information of the object. In this case, the updated location information of the object is relatively determined depending on location information of other objects. That is, the user can extend the dimension of the locative space so as to extend thinking. For example, referring to FIG. 8, the control unit 152 that controls a temporary storage space 320 for providing the 2D space can generate other 2D locative spaces 330, 340 and 350, thus providing a 3D space. The newly generated spaces 330, 340 and 350 have location information relative to the originally located space 320. Therefore, as shown in FIG. 9, when objects included in the temporary storage space 320 are shifted to other spaces 330, 340 or 350, the control unit 152 updates location information of the respective objects depending on the shift of the objects. Further, the control unit 152 can output the data included in the objects as a document. For example, in order to output a document, the control unit 152 may output the document in the same form as that in which the objects are arranged, without change. Furthermore, for example, the control unit 152 allows the user to arbitrarily select objects so as to output a document, and enables data included in the selected objects to be arranged on and output as a document in the sequence in which the objects are selected. In this case, as the document, any application can be used as long as it allows the user to easily edit data as in the case of an MS word document, a PowerPoint document, or a unique document format devised to be able to represent the contents of and the relations between the objects.

The storage unit 153 may also store data required to operate the control unit 152 and the interface unit 151. That is, the storage unit 153 may store information input or output via the interface unit 151, store objects or locative spaces generated by the control unit 152, or store the updated location information or data of objects.

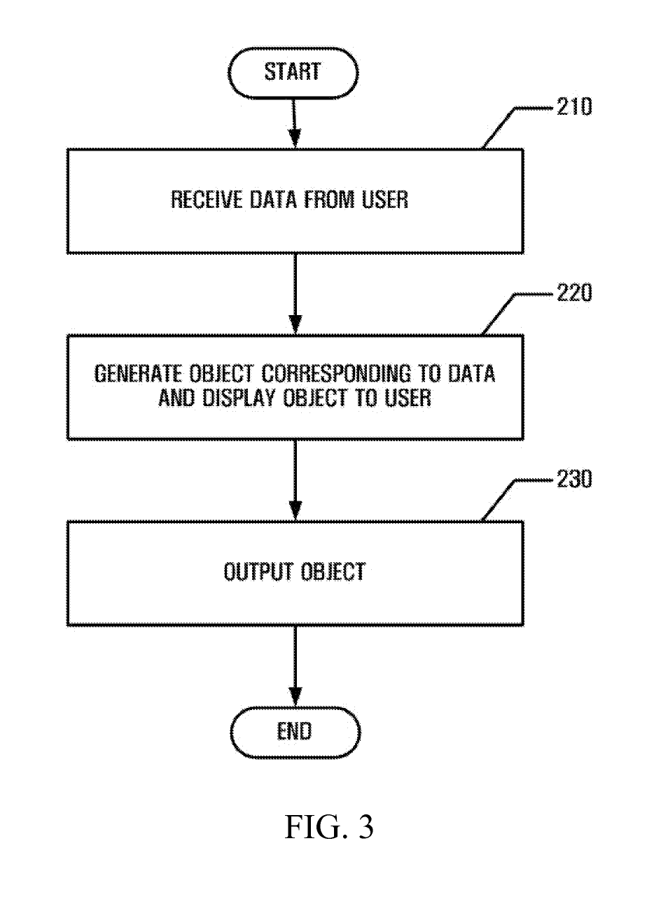

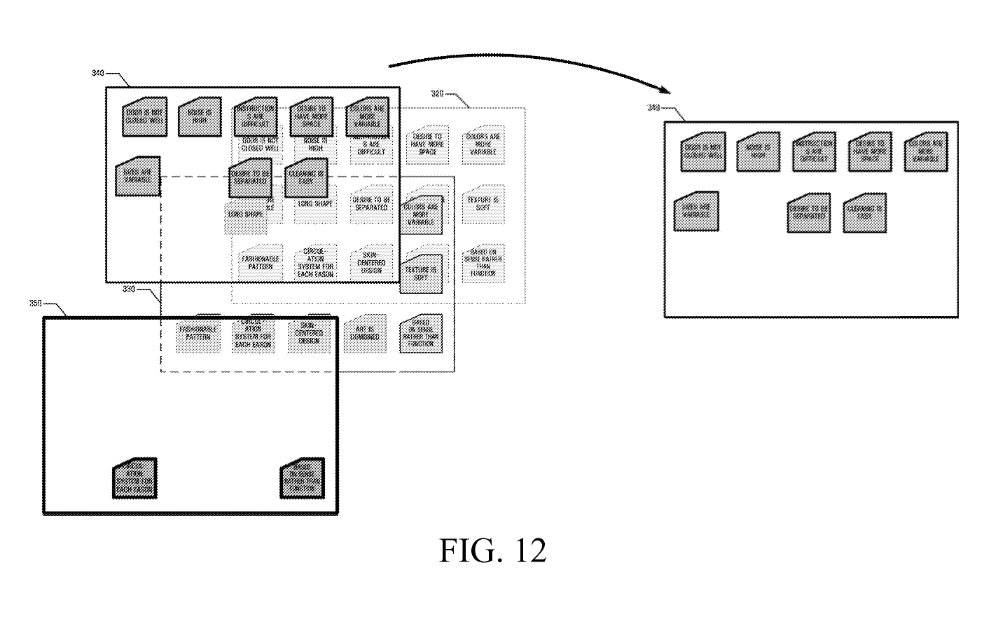

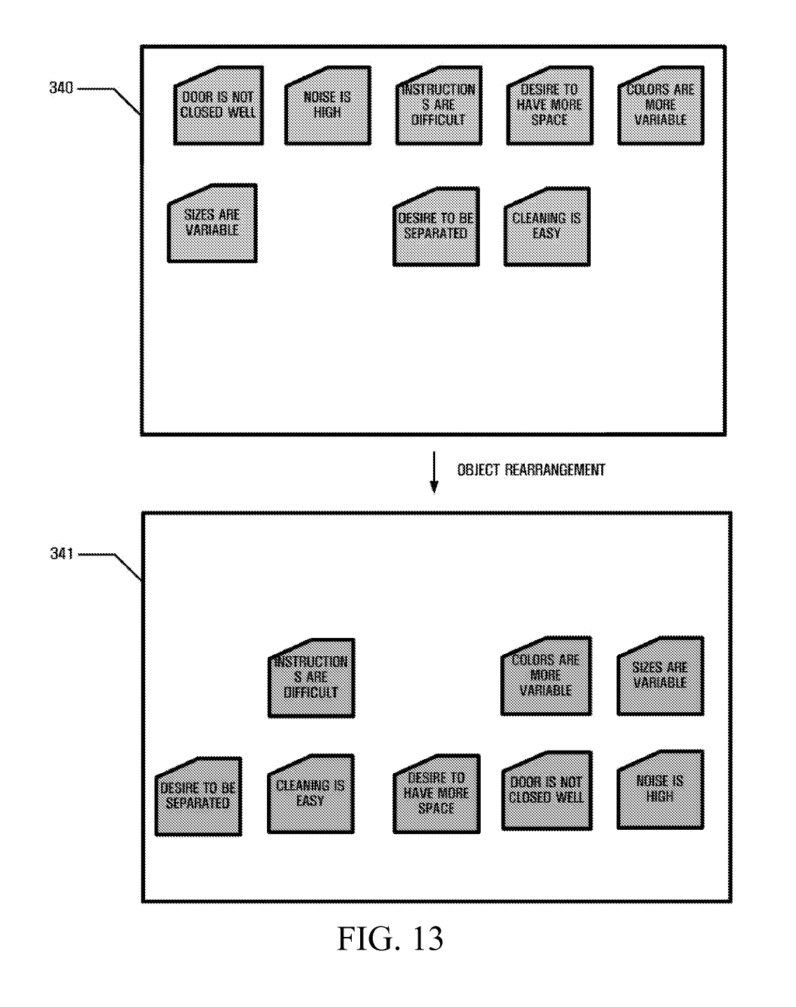

FIG. 3 is a flowchart showing a method according to an embodiment of the present invention. When data is received from the user via the interface unit, the control unit generates an object including the data at step 210. The generated object includes location information, which may contain any value or alternatively contain location information input by the user. The object is displayed to the user via the interface unit according to the location information included therein at step 220. When the user shifts the object, information about a location changed according to the shift becomes new location information of the object, and thereafter connective relationships among the object and other objects may be input. In this case, the connective relationships among the objects may be a relationship having association (a conceptual correlation), a hierarchical relationship (a conceptual inclusive relation), or the like. Such a connective relationship may be input using a method of arranging an object to be adjacent to other objects having a correlation therewith, a method of connecting the object to other objects and arranging the object at a height higher or lower than or identical to that of the other objects, or a method of locating the object in a locative space generated by extending a dimension (for an illustration related to this, see FIGS. 12 and 15 to 17). These objects may be output to a document. In particular, they can be output to a document in a form in which the objects are currently displayed, without change. Alternatively, data included in the selected objects can be output as the document in the sequence of the objects selected by the user (or the system). A series of the above-described steps may be continuously repeated.

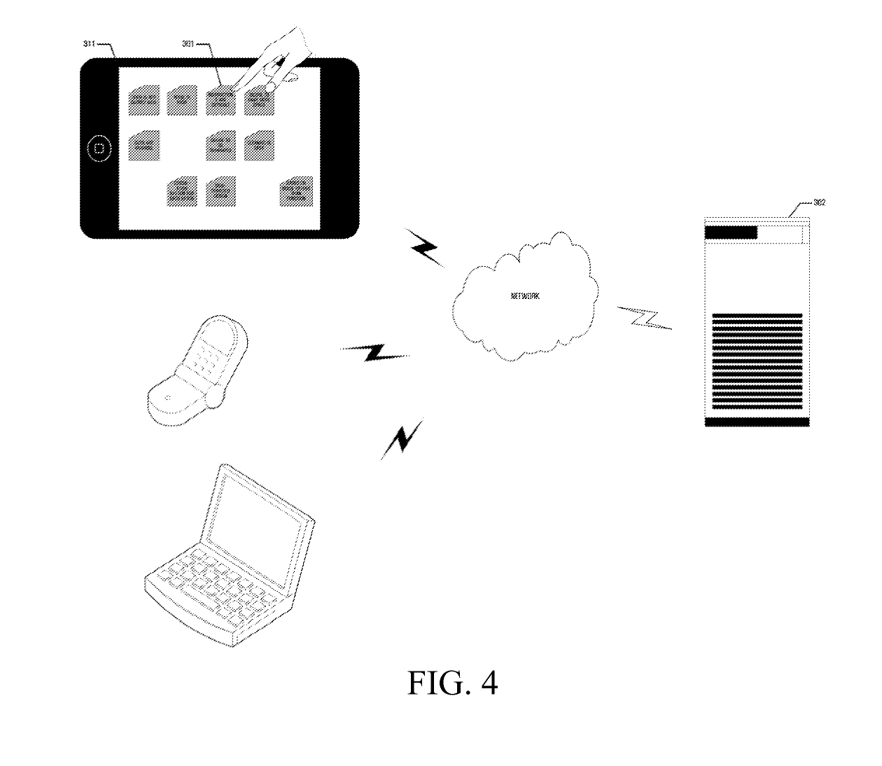

Below, preferred embodiments will be described in relation to the operation of the idea creation supporting system. For this, FIGS. 4 to 18 illustrate a process in which a system user of the present invention is a dealer in electric home appliances and creates ideas required to improve products by referring to customer responses to electric household appliances. Further, in FIGS. 8 to 12 and FIG. 18, objects indicated by the same color denote objects located in the same locative space, and portions indicated by dotted lines denote portions overlapping other locative spaces or other objects.

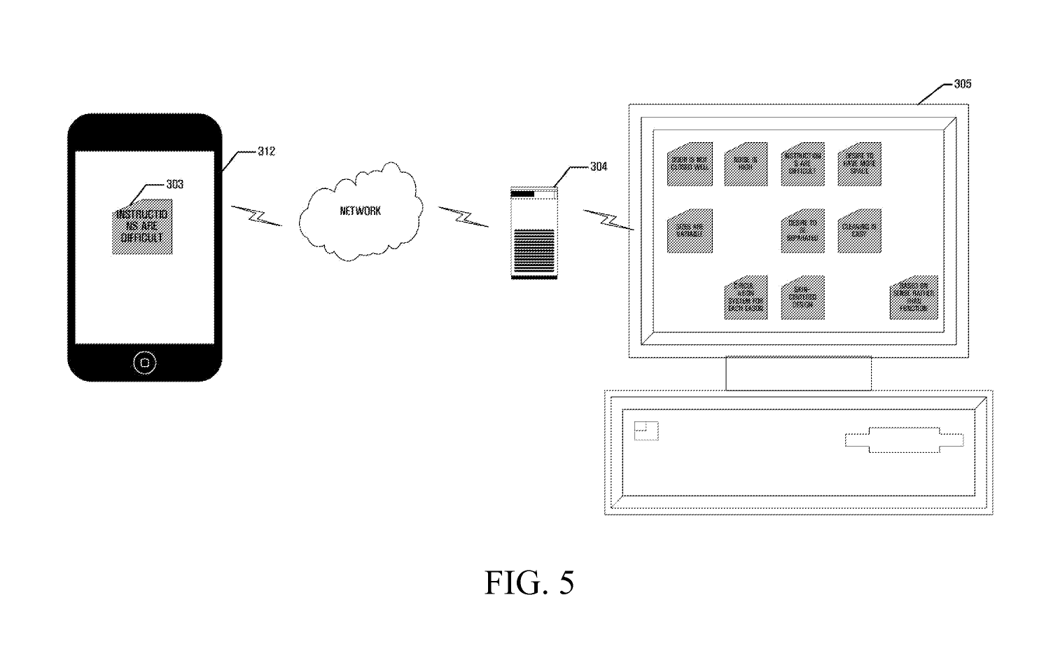

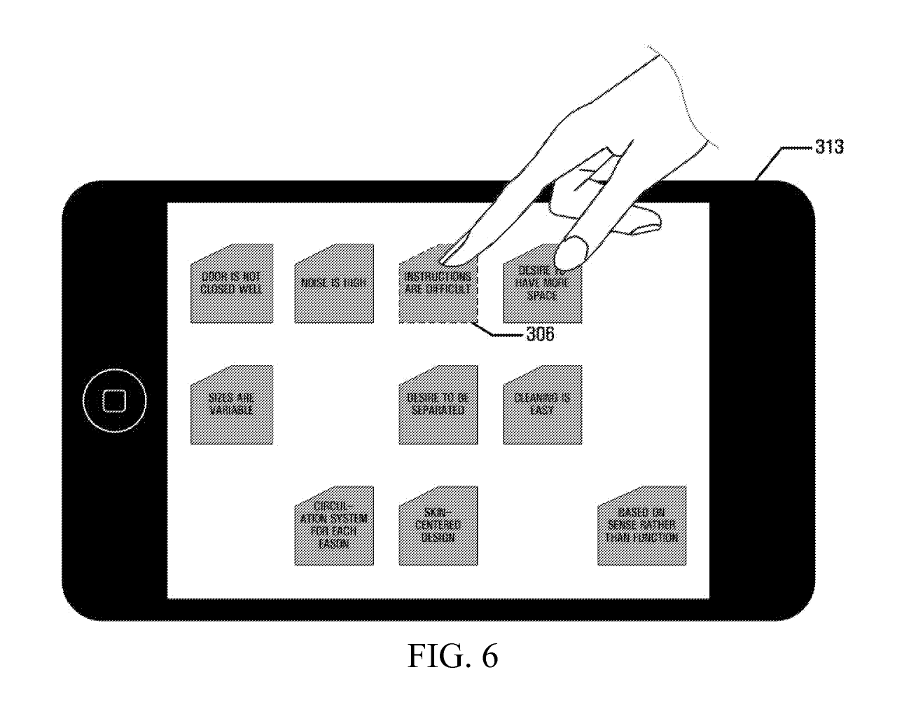

The user discovers a problem in that it is difficult for a customer who begins to use a washing machine to manipulate the washing machine while selling electric home appliances, and defines the problem as an idea of “instructions are difficult.” Such an idea is processed by the idea creation supporting system. For convenience, objects are assumed to each have the shape of a note, and the user builds the idea into data by recording the idea on an object displayed on the terminal. The object includes location information set by the user, or randomly set location information. For example, referring to FIG. 4, the interface unit of the idea creation supporting system is provided via the terminal 311 of the user, and the control unit and the storage unit of the idea creation supporting system are included in a cloud server 302. Accordingly, when the user inputs his or her idea through the interface unit, the server 302 processes an object 301 via continuous communication with the terminal 311. Further, referring to FIG. 5, the terminal 312 of the user includes the interface unit of the idea creation supporting system, and then the user inputs an idea via the interface unit. The idea can be temporarily stored in a cloud server 304 located in several places and be edited by the user, and is downloaded to and processed by a tool 305 (for example, the desktop or the like of the user) including the idea creation supporting system. Further, for example, referring to FIG. 6, the idea creation supporting system is included in the terminal 313 of the user, so that the user can access the system through the interface unit of the idea creation supporting system included in the terminal 313 itself, and may record a new idea in an area between existing multiple objects (that is, previously recorded ideas) (in other words, the user inputs the location information of the idea by recording the idea in the inter-object area, and then the system may generate an object 306 including the location information and the idea). A method of processing ideas using the idea creation supporting system is not limited to the above example, and those skilled in the art will appreciate that data input by the user can be transferred to the system via various methods.

FIG. 7 is a diagram showing a form in which ideas randomly recorded by the user in FIGS. 4 to 6 are stored. Ideas are included in corresponding objects, respectively, and are displayed on the temporary storage space 320 of the system according to the present invention. In this case, the temporary storage space 320 may be formed in any of various shapes that include objects and are capable of displaying the objects to the user and that have such a boundary as to be distinguished from other spaces. For example, as shown in FIG. 7, the temporary storage space 320 may be formed in the shape of a board in which ideas can be displayed to allow the user to view his or her ideas at a glance. The location information of the objects included in the locative space 320 have relative values. For example, if it is assumed that the location information of an object located in a bottom leftmost portion of the space, that is, an object including data of “fashionable pattern,” is set to (1, 1) (simultaneously, x and y values of the location information are set to integers), it can be seen that an object including data of “instructions are difficult” has location information (3, 3). The user can view a collection of ideas recorded by the user at a glance and can take into consideration relationships among the ideas.

In FIGS. 8 to 18, a process in which the user creates an idea using ideas temporarily stored in FIG. 7 is illustrated. The user can intuitively recognize that ideas related to a washing machine can be mainly classified into strategy-related ideas, problem-related ideas, and proposal-related ideas by referring to the ideas displayed in the temporary storage space 320 of FIG. 7, and can extend the dimension of the temporary storage space 320, as shown in FIG. 8, so as to classify and store those ideas. That is, in the early stage of the process, the dimension of a space in which temporarily stored ideas are located is set to two dimensions, but the dimension of the locative space can be extended to 3D so as to classify and separately store the ideas. As a result of the extension, a strategy space 330, a problem space 340 and a proposal space 350 are generated, and the respective locative spaces are freely arranged. As described above, the user can extend a 2D space to a 3D space, and the extension of a dimension can be implemented up to n dimensions as long as it can provide the intuitive recognition of ideas to the user. According to the extension of a dimension, the control unit of the present invention can update location information. For example, referring to FIG. 8, the object including data of “instructions are difficult” initially includes location information (3, 3), but with the extension of a dimension, the location information comes to have a value on a z axis. Accordingly, if it is assumed that the temporary storage space 320 has a value of 1 on the z axis, the object including the data of “instructions are difficult” includes location information (3, 3, 1). As shown in FIG. 8, the plurality of locative spaces can be simultaneously shown to the user, and can also be shown to the user while covering all or some of locative spaces by using various techniques such as a scrolling technique supported by recent smart phones.

Meanwhile, objects having the same data may be shifted to various spaces or dimensions, or duplicated to and located in the spaces or dimensions. For example, referring to FIG. 9, an object including data of “based on sense rather than a function” is located in the temporary storage space 320 and is also duplicated to and located in the proposal space 350. In this way, the user can suitably and freely duplicate and shift objects to other spaces and can also duplicate and shift a plurality of locative spaces. This shift is dependent on the intuition of the user based on the embodiment of his or her ideas, and is then effectively used in the creation of ideas of the user. That is, the system of the present invention allows the user to intuitively recognize relations between ideas by allowing the user to freely rearrange the ideas, thus facilitating the creation of ideas of the user.

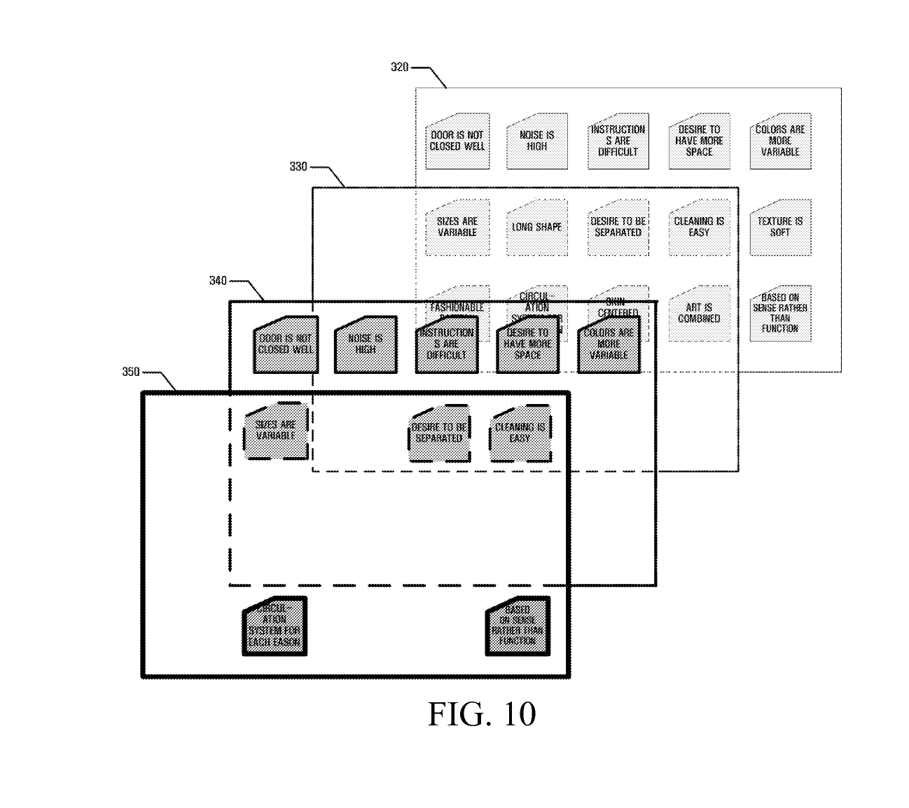

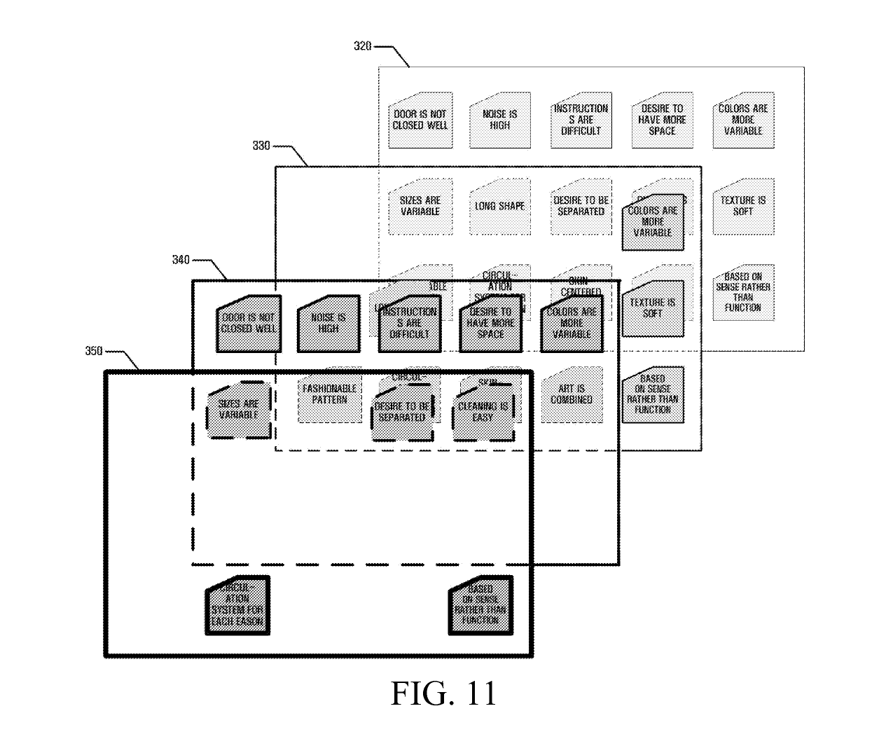

In FIG. 10, a state in which objects are duplicated from the temporary storage space 320 to the problem space 340 is shown. For example, an object including the data of “cleaning is easy” located in the temporary storage space 320 is duplicated to and located in the problem space 340. Similarly, FIG. 11 illustrates a state in which objects are selectively duplicated from the temporary storage space 320 to the strategy space 330.

Meanwhile, the user needs to extend the dimension of his or her thinking so as to create ideas. For this, the present invention enables the dimension of locative spaces to be extended. In relation with this, since human cognitive power is limited to three dimensions, a display screen provided by the interface unit to the user provides such a 3D locative space. However, since the locative space can be extended to n dimensions, this extended dimension is processed in the form of a 3D image and provided to the user. That is, a single locative space is selected from among the existing locative spaces, and the dimension of the selected locative space is extended, thus enabling the dimensions to be continuously extended. For example, when the user selects the problem space 340, the problem space 340 is duplicated or, alternatively, the original thereof can be separately displayed to the user. FIG. 12 shows an example in which the original of the problem space 340 is displayed to the user. Further, if the user determines that there is a need to extend the dimensions of the problem space 340, other locative spaces 342 and 343 are generated, as shown in FIG. 14, while the dimension of the problem space 340 which is a 3D space is extended to four dimensions.

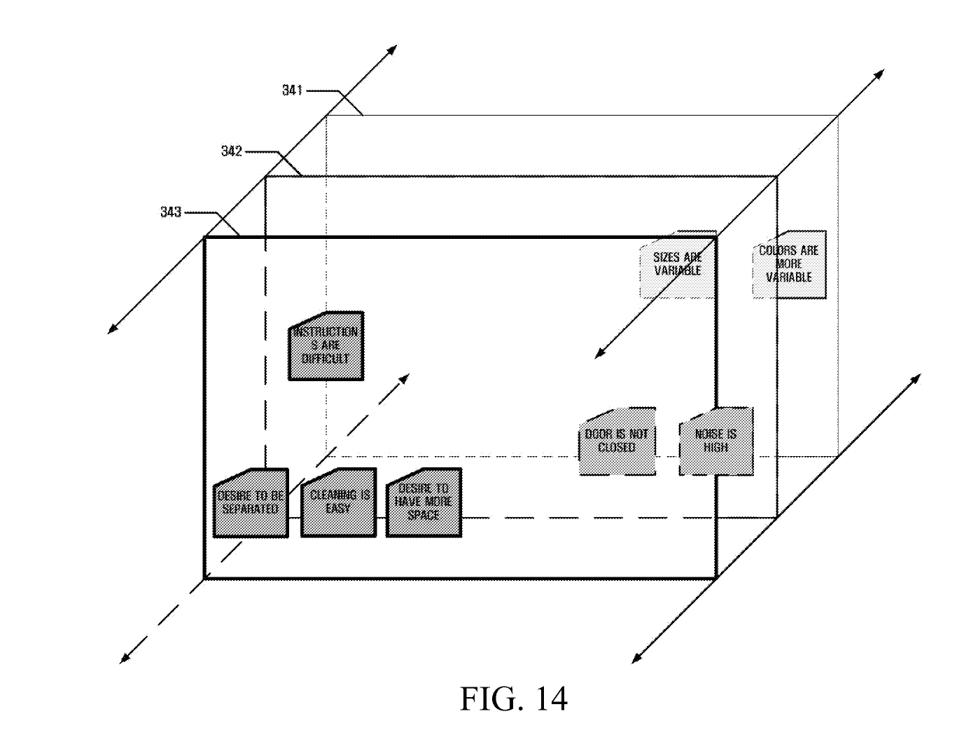

Of course, it is apparent that the user not only can extend the dimension of the locative spaces but also can create ideas by utilizing existing locative spaces. That is, the user can rearrange the locations of objects in the same locative space at any time. In regard to this, referring to FIG. 13, the locations of the objects arranged in the problem space 340 can be rearranged. That is, for example, if the user determines that it is suitable to locate an object including data of “desire to be separated” at the bottom leftmost portion of the locative space according to his or her intuition, the location of the object in the problem space 340 is changed to that of the object in a problem space 341, and thus information about the updated location is stored in the storage unit. In this way, the user can rearrange objects located in the same space and create new ideas from the rearranged ideas.

Meanwhile, as described above, the dimension of the extended locative space can be re-extended. As shown in FIG. 14, the user can intuitively recognize that ideas in the problem space 340 can be classified into planning-related problems and technical problems with reference to the problem space 340, and can reconstruct ideas based on the separately extracted problem space 340. That is, the dimension of the space of FIG. 8 that was the 3D space is extended. However, since the cognitive ability of a human being is limited to 3D, a scheme for displaying the extension of the dimension to the user complies with the following scheme. That is, the present invention defines the dimension of the problem space 341 as 2D and generates a planning-related problem space 343 and a technical problem space 342 while extending the dimension of the problem space 341 to 3D, in order to intuitively display a 4D space to the user. As a result, the user can shift the objects located in the problem space 341 to the planning-related problem space 343 and to the technical problem space 342 (that is, an inclusive relation in which the locative spaces 341, 342, and 343 are included in the locative space 340 is established among locative spaces 340, 341, 342, and 343). For example, as shown in FIG. 14, an object including the data of “instructions are difficult” can be shifted from the original problem space 341 to the planning-related problem space 343.

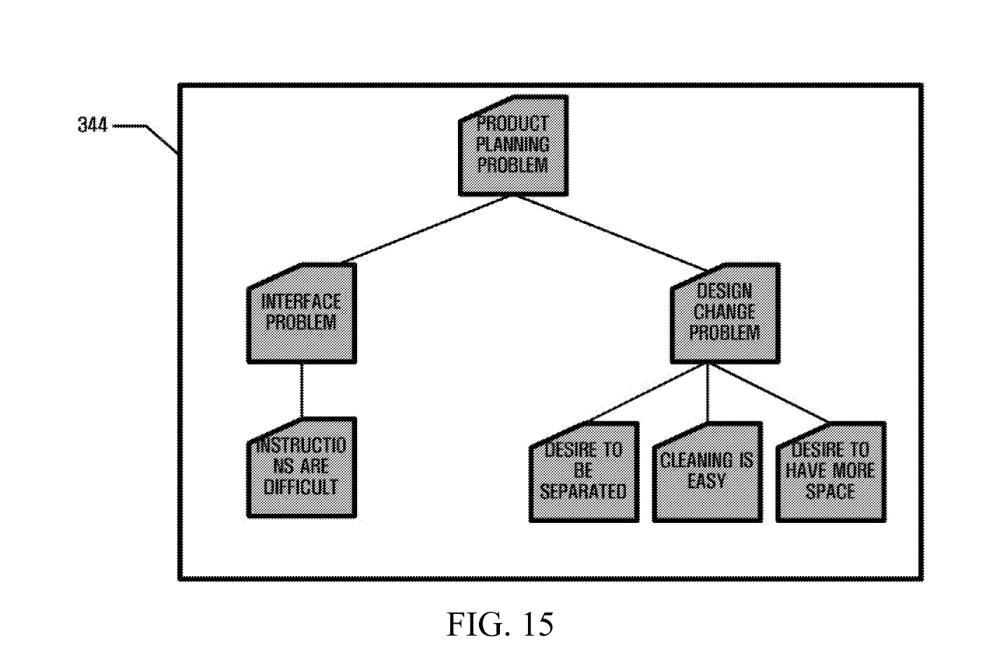

Meanwhile, the user can establish a relation between displayed objects. That is, the user can establish the hierarchy and correlations between objects including data depending on the hierarchy and correlations between the data. When the user recalls the superordinate concept of data included in the respective objects as a new idea, the user can generate a new object corresponding to the idea, connect the object to existing objects as a superordinate concept, and store such a connective relationship (for example, it can be assumed that a connective relationship is valid among objects connected via a line and that an object in an upper portion among the objects having the valid connective relationship [with respect to the y axis of the 2D locative space] includes data corresponding to a superordinate concept, and an object in a lower portion includes data corresponding to a subordinate concept). For example, as shown in FIG. 15, it is recognized that the idea of “cleaning is easy” can be classified as “design change problem ” that is a superordinate concept, and an object including the data of “design change problem” is generated and is then arranged as the superordinate concept of the idea of “cleaning is easy.” In this way, superordinate concepts can be extracted and relationships among individual ideas (that is, which ideas are superordinate concepts and which subordinate concepts are present under the superordinate concepts) can be obtained. Further, when the user discovers that parts of the objects have concepts associated to each other, the parts of the objects are connected via a line or are arranged immediately close to each other, and then the relationships can be stored. For example, as shown in FIG. 15, it is determined that the idea of “cleaning is easy” is associated with “desire to be separated” (according to the user's intuition that the entire area can be cleaned only if the washing machine is properly separated), the object including the data of “cleaning is easy” and the object including the data of “desire to be separated” can be located adjacent to each other. When the connective relationships among objects are established in this way, the user can determine the structures between his or her ideas and can configure a document from the structures. That is, data can be output without change in the arrangement sequence of the objects of the planning-related problem space 344 shown in FIG. 15. Further, objects arranged in the planning-related problem space 344 of FIG. 15 can be output in the sequence of objects selected by the user. For example, when the user selects objects in the sequence of “product planning problem,” and “interface problem” and “design change problem”, data included in the objects can be output as a document in the above sequence. Based on the document, the user can derive the fact that “I discovered the necessities to re-plan products while purchasing washing machines, and discovered especially that there is a need to change the interface and the design.” In this way, the user can inductively construct ideas that randomly occurred to the user, thus creating new ideas.

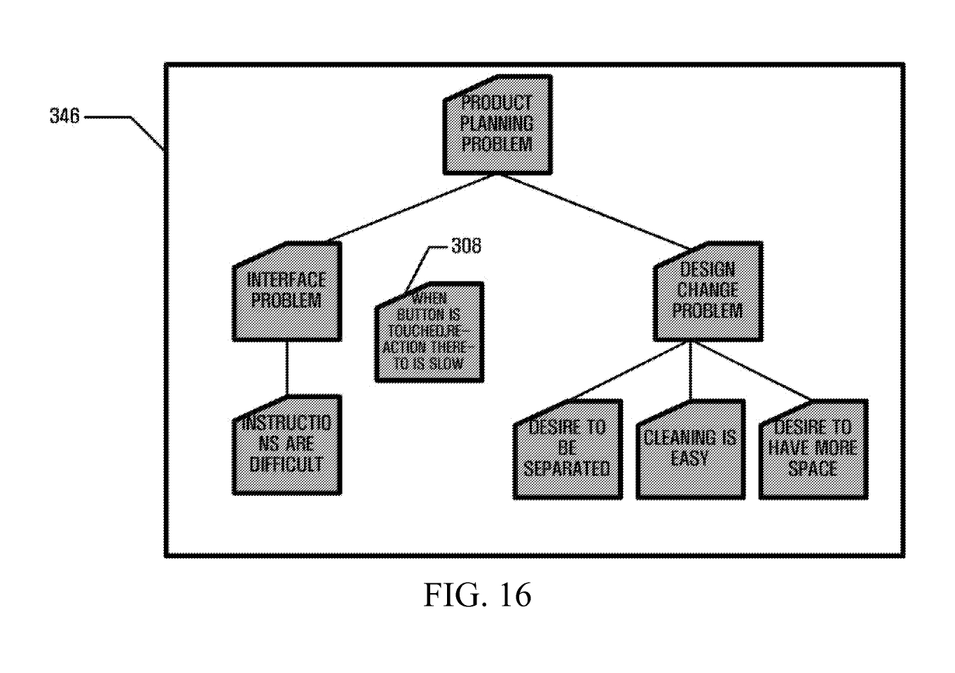

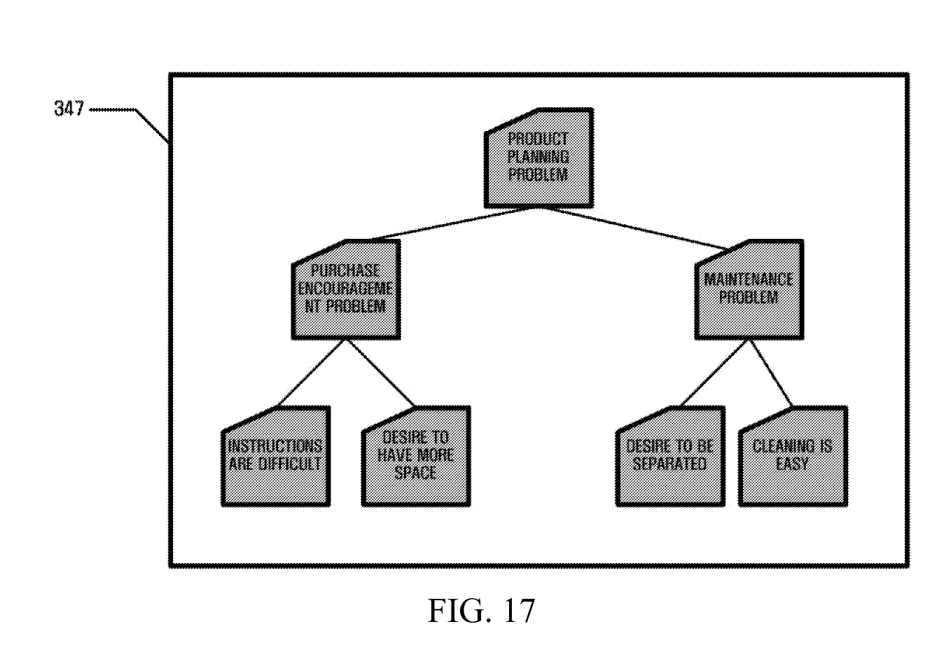

Meanwhile, if it is determined that contents included in the document are not suitable, the present invention allows the user to rearrange objects or add new ideas, as shown in FIGS. 16 and 17, thus allowing the user to create new ideas.

As shown in FIG. 16, when a new idea of “when a button is touched, a reaction thereto is slow” occurred to the user, an object 308 including the idea can be generated. If the user determines that the idea is associated with “interfaces problem” to some degree even if it cannot be exactly determined that the idea is regarded as “interfaces problem,” the object 308 can be arranged adjacent to the object including the data of “interfaces problem.”

Further, as shown in FIG. 17, it is apparent that objects of the planning-related problem space 343 of FIG. 14 can be rearranged, and that superordinate concepts other than the superordinate concepts extracted in FIG. 15, that is, “interfaces problem” and “design change problem,” can be derived. For example, the user may rearrange the data of “desire to be separated” and “cleaning is easy” into a single group, and may derive, from the group, a superordinate concept that is an item to be considered by a seller upon providing maintenance for repair after a washing machine purchaser purchased a washing machine, that is, “maintenance problem” as a new idea. Then, the user may generate an object corresponding to the new idea and newly add the object to the planning-related problem space 347. The planning-related problem space 347 constructed in this way can be output to and kept in the document. Further, when the user selects ideas in the sequence of “product planning problem,” “purchase encouragement problem,” and “maintenance problem,” the ideas are output to the document in the sequence in which the ideas are selected. On the basis of the document, the user can inductively derive the fact that “I discovered the necessities to re-plan products while purchasing washing machines, and discovered especially that there is a need to plan products so that customers are encouraged to purchase products and to easily maintain the products after the purchasing of the products.”

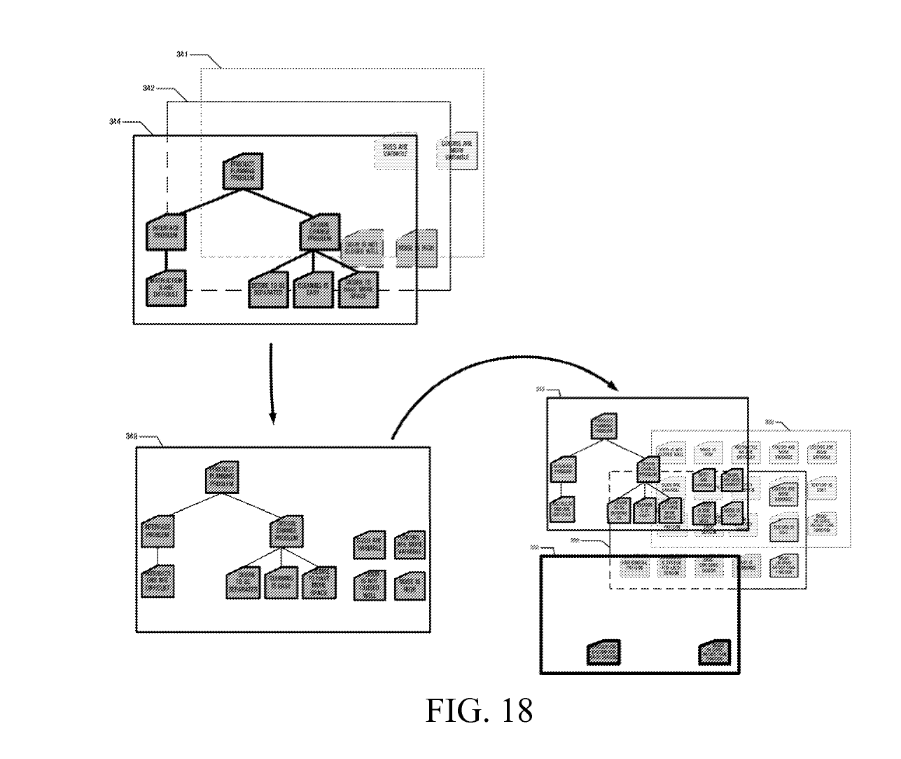

As shown in FIG. 18, a problem space 349 newly constructed through the above-described process can be displayed to the user in a shape in which the problem space 349 is rearranged among the temporary storage space 320, the strategy space 330, and the proposal space 350. That is, a structured planning-related problem space 344 that was present in a 4D space is merged with other spaces 341 and 342 present in another 4D space (or the spaces 341, 342, and 344 are duplicated, so that the original space is prevented from being damaged, and the duplicated spaces are merged), so that the space 341, 342, 344 may be structured in the form of the problem space 349 present in the 3D space. Further, relations which the problem space 349 has with respect to the existing spaces 320, 330, and 350 that are originally present are displayed to the user.

Meanwhile, the above-described locative spaces may be designated as being accessed by a third party other than the user, so that the user can share ideas created by the user with the third party via such designation. Further, the user may assign the right to shift/exchange/duplicate objects to the third party, and may set the right differently for respective locative spaces. Based on such assignment, the user can create new ideas in cooperation with the third party.

As described above, the user not only can record and preserve a large quantity of ideas by documenting discovered or generated ideas via the system of the present invention, but also can easily determine relationships between the ideas by spatially visualizing relations between the ideas, and can create new ideas based on the ideas.

Those skilled in the art will appreciate that various exemplary logic blocks and algorithm steps that have been described in relation with the disclosed embodiments can be implemented as electronic hardware, computer software or combinations thereof In order to definitely describe this replaceability of hardware and software, various exemplary steps have been mainly described from the standpoint of the functionality thereof Whether those functionalities are to be implemented using hardware or software depend on the specific applications and design constraints imposed on the entire system. Those skilled in the art can implement the above-described functions in various manners with respect to individual specific applications, but such determinations regarding implementation should not be interpreted as departing from the scope of the present invention.

That is, the above embodiments are merely embodiments for describing the present invention in detail, and the present invention is not limited to those embodiments. Various additions, omissions, substitutions, and other modifications are possible, without departing from the scope and spirit of the invention. The present invention is not limited to the above description and is limited only by the accompanying claims.

### INDUSTRIAL APPLICABILITY

The present invention can create new ideas. Further, the present invention can provide a tool for facilitating the creation of new ideas. Furthermore, the present invention can easily visualize one or more ideas and easily determine structures between the ideas. Furthermore, the present invention can detect structures between ideas in a short period of time. Furthermore, the present invention can support the inductive thinking of a user. Furthermore, the present invention can simulate structures between ideas and continuously change the structures between the ideas based on the results of the simulation, thus finding a suitable structure between the ideas.

What is claimed is:

1. A method of supporting creation of ideas, the method managing data by an idea creation supporting system which supports creation of ideas of a user by visualizing conceptual relations between ideas as spatial relations, comprising:
receiving data from the user, generating an object including the data, and arranging the generated object in an arbitrary locative space;
receiving a connective relationship between parts of a plurality of objects that include the generated object from the user; and
allowing the user to select objects to be output from among the plurality of objects, and outputting data included in the selected objects as a file in a sequence in which the objects are selected,
wherein the receiving the connective relationship between the parts of the plurality of objects comprises,
additionally generating a certain locative space other than an existing locative space, the certain locative space being a space obtained by extending a dimension of the existing locative space; and
arranging at least one of the parts of the plurality of objects in the certain locative space.

2. The method according to claim 1, wherein the receiving the connective relationship between the parts of the plurality of objects further comprises duplicating or shifting the parts of the plurality of objects.

3. The method according to claim 1, wherein the receiving the connective relationship between the parts of the plurality of objects further comprises receiving a hierarchical relationship between the parts of the plurality of objects.

4. The method according to claim 1, wherein the arbitrary locative space comprises a locative space that can be accessed by a certain user other than the user.

5. The method according to claim 4, wherein objects included in the locative space that can be accessed by the certain user can be duplicated or shifted by the certain user.

6. A system for supporting creation of ideas, the system supporting creation of ideas of a user by visualizing conceptual relations between ideas as spatial relations, comprising:
an interface unit configured to be able to communicate with the user and to receive data from the user;
a control unit configured to receive the data from the interface unit, generate an object including the data, and arrange the generated object in an arbitrary locative space; and
a storage unit configured to store the generated object,
wherein the interface unit additionally receives a connective relationship between parts of a plurality of objects that include the generated object from the user,
wherein objects to be output are selected by the user from among the plurality of objects, and data included in the selected objects are output as a file in a sequence in which the objects are selected,
wherein the control unit additionally generates a certain locative space which is a space obtained by extending a dimension of an existing locative space, in addition to the existing locative space, so as to receive the connective relationship between the parts of the plurality of objects, and
wherein at least one of the parts of the plurality of objects is arranged in the certain locative space.
